(19) United States
(12) Patent Application Publication
(10) Pub. No.: US 2014/0062061 A1
(43) Pub. Date: Mar. 6, 2014

(54) TRAILER AND HITCH SYSTEM AND METHOD

(71) Applicant: RoboteX Inc., Palo Alto, CA (US)

(72) Inventors: Adam M. GETTINGS, Red Wing, MN (US); Xiaoyang SHEN, Corona, CA (US); Edward John SILER, III, Sunnyvale, CA (US)

(73) Assignee: RoboteX Inc., Palo Alto, CA (US)

(21) Appl. No.: 14/017,296

(22) Filed: Sep. 3, 2013

Related U.S. Application Data
(60) Provisional application No. 61/696,066, filed on Aug. 31, 2012.

(51) Int. Cl. B60D 1/26; B62D 53/06

(52) U.S. Cl. CPC B60D 1/26; B62D 53/061
USPC 280/423.1

(57) ABSTRACT

A robot and trailer system is disclosed. The robot can have a hitch that can attach to the trailer. The hitch can he remotely controlled to release and detach the trailer from the robot. The front panel of the trailer can be rounded, for example to enable dragging over obstacles with a reduced risk of snagging or catching on the obstacle.

### CROSS-REFERENCE TO RELATED APPLICATION

This application claims priority to U.S. Provisional Application No. 61/696,066, filed 31 Aug. 2012, which is incorporated herein by reference in its entirety.

### BACKGROUND

1. Technical Field

The invention relates generally to the field of trailers and vehicle connection systems, for example automated release hitch systems.

2. Summary of the Art

Remote control robots are often limited in their volumetric capacity to carry cargo. Many robots are attached to trailers in order to increase their cargo carrying capacity.

The trailers are often manually attached and detached to the robots. This can present problems if the trailer becomes stuck but the robot needs to proceed with or without the trailer. If the operator can not detach the trailer from the robot, the robot and trailer may be unable to complete their task, at best, or may even be unretrievable. Also, if the trailer is carrying hazardous cargo, for example radioactive material to be left in a remote location, it would be undesirable for the operator to be near the trailer, which would be required for the operator to manually remove the trailer from the robot.

Additionally, the ability for robots to navigate over obstacles, such as their ability to climb stairs or rocks may be critical to their usability. When attached to a trailer, robots climbing capability is often limited by the trailer, if not almost completely incapacitated. Accordingly, during attempted climbing of an obstacle, the robot may become stuck on the obstacle by the trailer. The front edge of the trailer may catch on the obstacle. Common trailers may be unable to climb the obstacle and unable to remotely detach from the robot, thereby leaving the robot and trailer stuck on the obstacle, or preventing the operator from risking an attempt to drive over the obstacle at all.

When the robot is driven in reverse, trailers often jackknife with respect to the robot. Typical trailers often tilt or tip over when the robot continues to drive in reverse with a jackknifed trailer resulting in a loss of cargo or obstruction of the robot (e.g., the trailer may get trapped under the robot while the robot continues to attempt to drive in reverse).

Accordingly, a robot and trailer assembly that is capable of remote control detachment of the trailer is desired. Furthermore, a trailer capable of climbing obstacles is desired. Also, a robot and trailer that prevent the trailer from tilting or tipping over when jackknifed is desired.

### SUMMARY OF THE INVENTION

A vehicular connection system is disclosed. The system can have a vehicle that can have a chassis and a hitch. The hitch is configured to be remotely controlled. The system can have a trailer. The trailer can have a bed, a wheel, and a coupler. The coupler can be releasably attachable to the hitch.

The hitch can be configured to be remotely activated by a wireless signal. The hitch can have a solenoid. The system can have a flipper rotatably attached to the robot chassis. The bottom of the front frame of the trailer can have a radius of curvature of less than about 12 in. The front bottom panel can be at an angle of less than about 50° with respect to the bed. The vehicle can be or have a robot. The robot can be configured to be remotely controlled. The vehicle can be configured to be remotely controlled.

A trailer is also disclosed. The trailer can have a frame, a bed attached to the frame, a coupler attached to the frame, and a wheel having a wheel axis. The wheel axis is attached to the frame. The bottom of the front frame of the trailer has a radius of curvature of less than 12 in. The front bottom panel can be at an angle of less than about 50° with respect to the bed. The rear bottom panel can be at an angle of less than about 50° with respect to the bed. The frame can be lower than the bed. The wheel axis can be above the bottom of the frame.

A method of using a vehicular connection system is disclosed. The method can include attaching a first vehicle to a trailer, remotely controlling the first vehicle, and detaching the first vehicle from the trailer. Remotely controlling can include sending a signal from a control unit to the first vehicle. Detaching can include sending a wireless signal to the first vehicle. The first vehicle can be or have a robot.

The first vehicle can have a hitch. The hitch can have a solenoid. Attaching the first vehicle to the trailer can include actuating the solenoid. Detaching the first vehicle from the trailer can include deactivating the solenoid.

### BRIEF DESCRIPTION OF THE DRAWINGS

FIG. 1 illustrates a variation of the robot attached to a variation of the trailer.

FIGS. 2a through 2f are front perspective, rear perspective, bottom-front perspective, bottom-rear perspective, top, and side perspective views, respectively, of a variation of the trailer.

FIGS. 3a and 3b are top and rear perspective views, respectively of a variation of the hitch.

FIGS. 4a and 4b are top and rear perspective views, respectively of a variation of the hitch in a first position.

FIG. 4c′ illustrates a variation of the receiver.

FIGS. 5a and 5b are top and rear perspective views, respectively of the variation of the hitch of FIGS. 4a and 4b in a second position.

FIGS. 6a and 6b are top and side cross-sectional views of a portion of variations of the hitch during a method of sliding the receiver into the remainder of the hitch.

FIG. 7 is a side cut-away view of a portion of a variation of the hitch during a method of locking the receiver to the remainder of the hitch.

FIG. 8 is a top cross-sectional view of a variation of the hitch during a method of releasing and detaching the receiver from the remainder of the hitch.

FIGS. 9a through 9c are front perspective views of a variation of the hitch during a method for attaching the receiver to the remainder of the hitch.

FIGS. 10a through 10d are partial see-through perspective, front, front left perspective, and front right perspective views, respectively, FIGS. 10b and 10c are shown without (or shown in see-through) the hitch frame or hitch lid for illustrative purposes.

### DETAILED DESCRIPTION

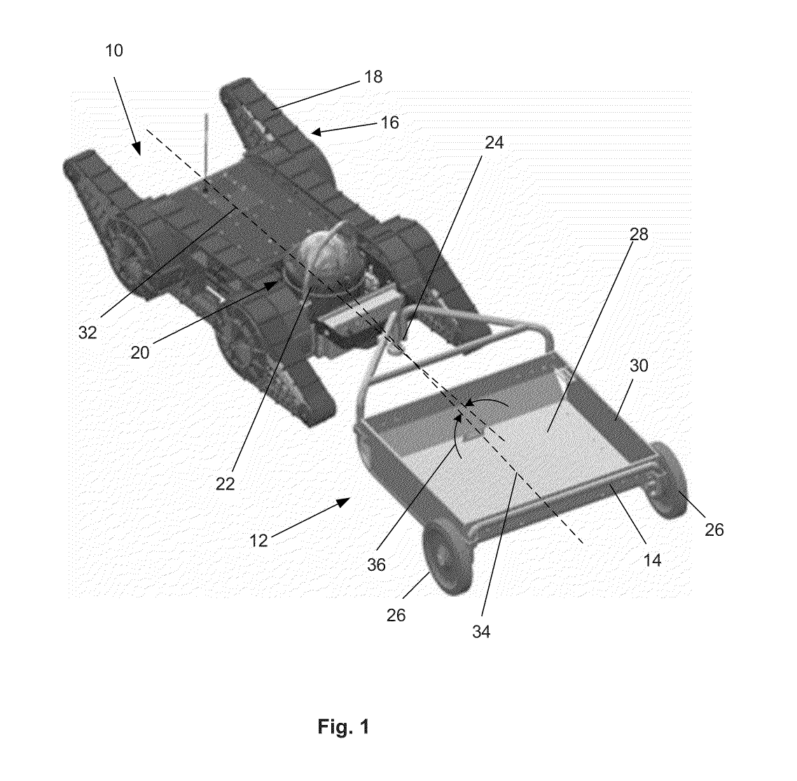

FIG. 1 illustrates that a robot 10 can be removably attached to a trailer 12. The trailer 12 can have a trailer frame 14. The robot 10 can be the robot as described by, or have any combination of elements thereof as described by U.S. Pat. No. 8,100,205, issued 24 Jan. 2012, or U.S. Provisional Patent Application No. 61/586,238, filed 13 Jan. 2012, both of which are incorporated herein by reference in their entireties. For example, the robot 10 can have one, two, four or more flippers 16 rotatably attached to the robot chassis. The flippers 16 can have tracks 18 that can translate around the body of the flipper 16 to translate and steer the robot 10. The robot 10 can have a payload bay 20 into which payload 22 can be mounted and electronically connected to the robot 10. For example, the payload 22 can be a rotatable camera, a chemical sensor, a robotic arm, or combinations thereof. The robot 10 can have cameras, display screens, microphones, speakers, radios or combinations thereof. The robot 10 and payload 22 can be controlled by remote control. The robot 10 and payload 22 can transmit data, such as audio, video, sensed environmental data (e.g., chemical levels, temperature), or combinations thereof, to and/or from a remote control unit.

The robot 10 can have a hitch 24. The hitch can extend rearward from the rear end of the robot. The hitch can removably attach to the front terminal end of the trailer or trailer frame. The remote control unit can send wireless signals to the robot 10 to control the robot 10, for example to drive the robot 10 and to actuate the hitch 24 to detach the trailer 12 from the robot 10.

The trailer frame 14 can be made from tubular lengths of hard plastic and/or metal, for example aluminum or steel.

The trailer 12 can have wheels 26. For example, the trailer can have one or two wheels 26 on each of opposite lateral sides of the trailer 12. The trailer wheels 26 can be attached to the terminal distal end of the trailer frame 14. The trailer wheels 26 can extend rearward of the remainder of the trailer 12.

The trailer 12 can have a flat trailer bed 28. The trailer bed 28 can be surrounded by trailer walls 30 extending vertically on all sides of the trailer bed 28. The trailer bed 28 and trailer walls 30 can be formed from a single panel or multiple panels. The trailer bed 28 and/or walls 30 can be made of mesh, fabric, wood, netting, rubber, concrete, or any other suitable material that can depend on the application the trailer 12 is used for, or combinations thereof. The trailer bed 28 and trailer walls 30 can be attached to the trailer frame 14.

The robot 10 can have a robot longitudinal axis 32. The trailer 12 can have a trailer longitudinal axis 34. The trailer longitudinal axis 34 and the robot longitudinal axis 32 can intersect at a trailer angle 36. The trailer angle 36 can change as the trailer 12 rotates with respect to the robot 10. The trailer angle 36 can be from about −120° to about 120°. For example, the trailer 12 can jackknife and the side of the trailer 12 can contact or abut one of the rear flippers 16 of the robot 10, such as when the robot 10 is driving in reverse.

The hitch 24 can have a single degree of rotational freedom about a vertical axis. :For example, the trailer 12 can be rotatably attached at the hitch 24 around an axis extending vertically (as shown in FIG. 1) through the hitch 24, but can be non-rotatably attached to the hitch 24 in other dimensions. For example, the trailer bed 28 of the trailer 12 can remain in the same plane when the trailer 12 is pushed, skidding backward by the robot 10 when the trailer 12 has jackknifed and the robot 10 is driving in reverse. (The trailer 12 can skid because the rotational axis of the trailer wheels 26 would be non-perpendicular to the direction of translation of the trailer 12 since the trailer 12 would be jackknifed and the side of the trailer 12 would be abutting the side of the robot 10.)

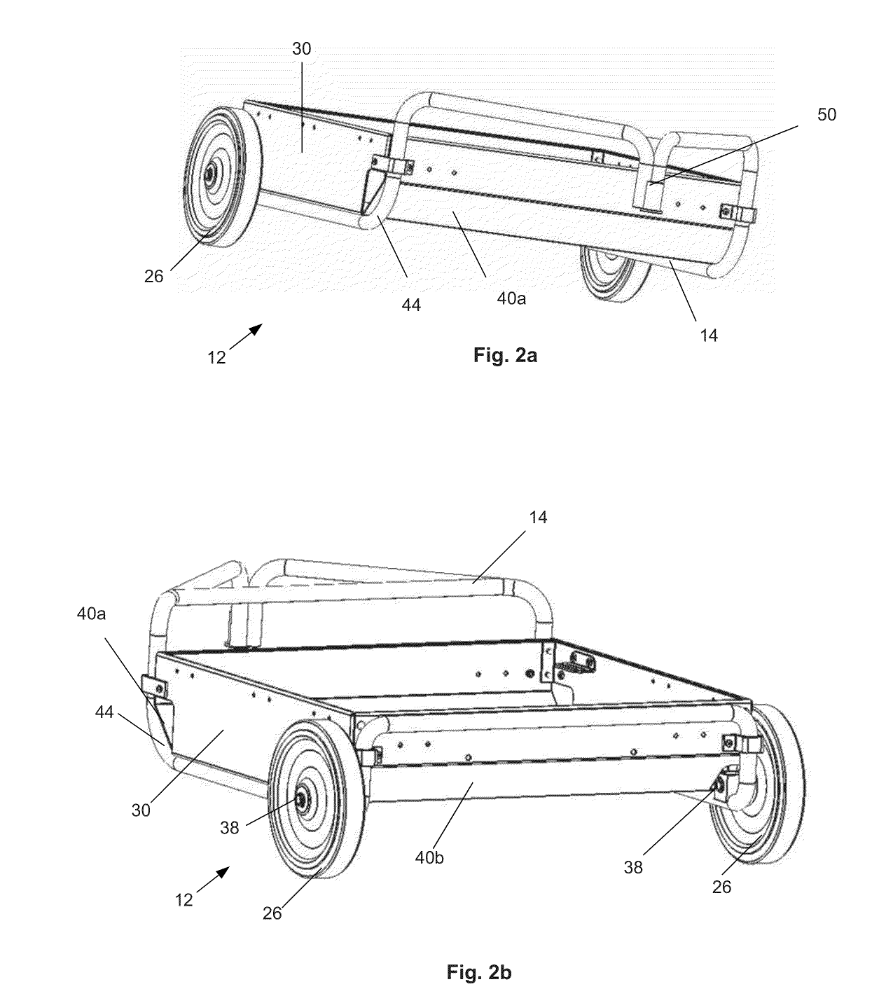

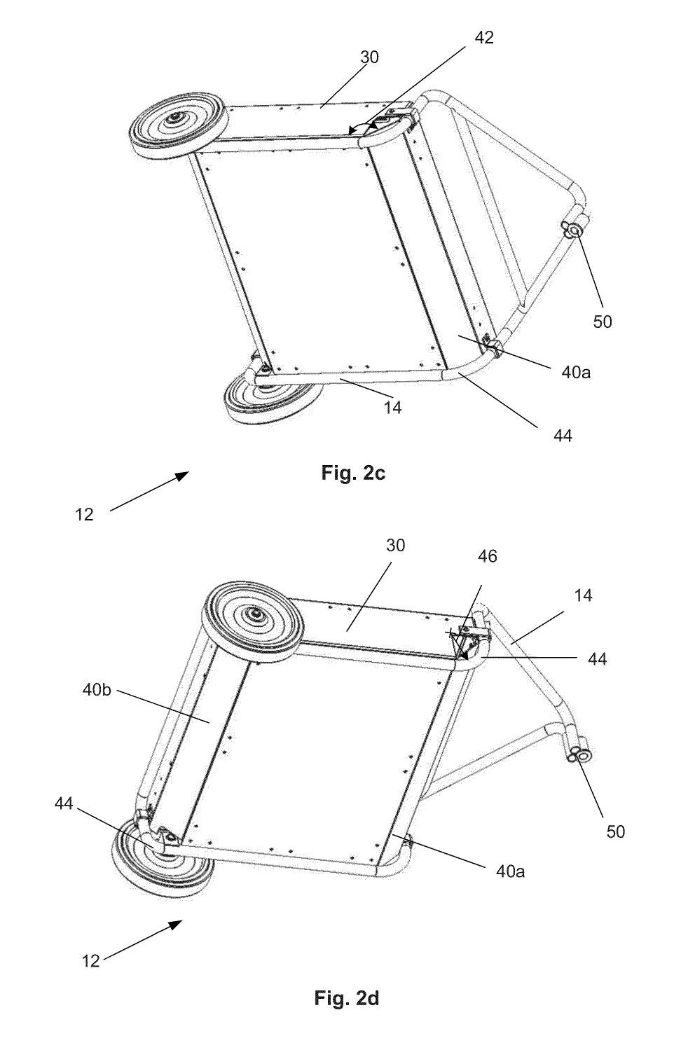

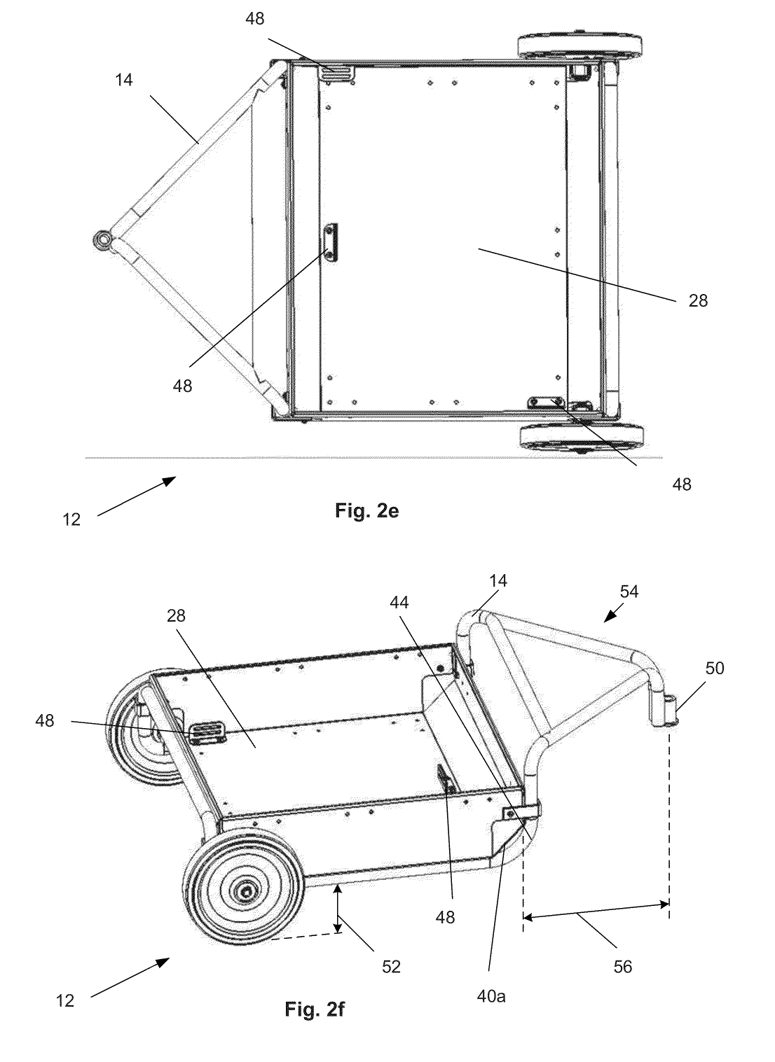

FIGS. 2a through 2f illustrate that the wheels 26 can be attached to the trailer frame 14 at the bottom and rear terminal ends of the trailer frame 14. The wheels 26 can rotate around wheel axles 38 centered in the wheels 26. The wheel axles 38 can be above, at the height of, or below the bed 28. The wheel axles 38 can be mounted above and on top of the bottom-most segments of the trailer frame 14.

The bottom front and/or bottom rear portions of the trailer wall 30 can slope toward the bed 28. For example, the bottom front portion can have a front slider 40a and/or the bottom rear can have a rear slider 40b. The sliders 40 can be angled, for example at slider angles 42 with respect to the respective adjacent plane of the bed 28 and/or to the top of the front and rear portions of the trailer wall 30. The slider angles 42 can be less than about 50° with respect to the bed, more narrowly less than 30°, for example about 45°.

The front bottom of the frame 14 that extends around the front slider 40a can be frame climber segments 44. The frame climber segments 44 can be curved at a frame climber radius of curvature 46. The frame climber radius of curvature 46 can be less than about 12 in., more narrowly less than about 6 in, yet more narrowly less than about 3 in., for example about 2.5 in. When the trailer 12 is pulled forward over an obstacle, the obstacle can slide against the front slider 40a and/or the frame climber segment 44. The front slider 40a and the frame climber segment 44 can abut and slide over the obstacle, pushing the trailer 12 up above the obstacle as the trailer 12 is pulled forward. The bottom of the frame 14 and/or bed 28 can slide over the obstacle. As the trailer is dragged over an obstacle, the obstacle can contact the wheels 26 below the mid-point, height-wise, of the wheels 26. (The wheels 26 can extend below the bottom of the frame 14 below the wheel axles 38.) As the trailer 12 is dragged forward, the wheels 26 can roll over the obstacle and push the trailer 12 up, for example preventing the obstacle from catching between the wheel 26 (above the mid-point, height-wise) and the frame 14. If the obstacle contacts the trailer 12 between the wheels 26 and not at both wheels, the Obstacle can slide along the rear slider 40b at an angle with respect to the bed, for example preventing the trailer from abruptly dropping off the cleared obstacle and delivering an impulse force to the trailer 12 and cargo in the trailer 12.

The wheels 26 can be made from nylon. The wheels 26 can have a width of from about 0.25 in, to about 0.75 in., for example about 0.5 in.

The trailer walls 30 can be open adjacent to the front slider 40a and/or rear slider 40b. For example, the openings in the trailer wall 30 can allow for drainage of liquids (e.g., rainwater, dirty water from washing the bed) or solids from the cargo area of the trailer 12.

The trailer 12 can have one or more anchoring tabs 48 attached to and extending from the trailer walls 30 and/or bed 28. The anchoring tabs 48 can have slots or ports, for example to attach to straps used to strap down cargo to the trailer bed 28 and/or walls 30. The trailer 12 can have anchoring tabs 48 positioned at diametrically, laterally, and/or longitudinally opposite ends of the cargo area. The anchoring tabs 48 can be positioned at the same and/or varying heights in the trailer 12. The anchoring tabs 48 can be oriented parallel relative to each other, perpendicular relative to each other, at non-parallel and non-perpendicular angles with respect to each other, or combinations thereof.

The frame 14 can extend over and in front of the bed 28. The front end of the frame 14 can terminate as a trailer coupler 50. The trailer coupler 50 can be a ball, a threaded bolt rotatably attached to the frame 14, a threaded washer or port (as shown), a rod of the frame 14, multiple rods, or combinations thereof. The trailer coupler 50 can be configured to attach to the hitch 24.

The height from the bottom of the wheels 26 to the bottom of the lower of the frame 14 or bed 28 (as shown in FIG. 2f) can be a frame clearance height 52. The frame clearance height 52 can be from about 1 in. to about 3 in., for example about 1.5 in.

The frame 14 can form a coupler extension 54 from the front of the bed 28 to the trailer coupler 50. The coupler extension 54 can be a gooseneck. The coupler extension 50 can be configured so the height and distance from the coupler 50 can clear the rear flippers 16 of the robot 10, for example when the trailer 12 is pulled by the robot 10 driving forward and when the trailer 12 is jackknifed (e.g., at a trailer angle of about 120° or −120°) when the robot 10 is driving in reverse.

The length from the front of the bed 28 or front trailer wall 30 to the coupler 50 can be a coupler extension length 56. The coupler extension length 56 can be from about 5 in. to about 15 in., for example about 7 in. The coupler extension 54 can be a length of the frame in a gooseneck configuration that can clear the rear flippers 16 when the robot 10 is turning, for example sharply, both clearing the frame's height, as well as the bed's distance from the coupler 50.

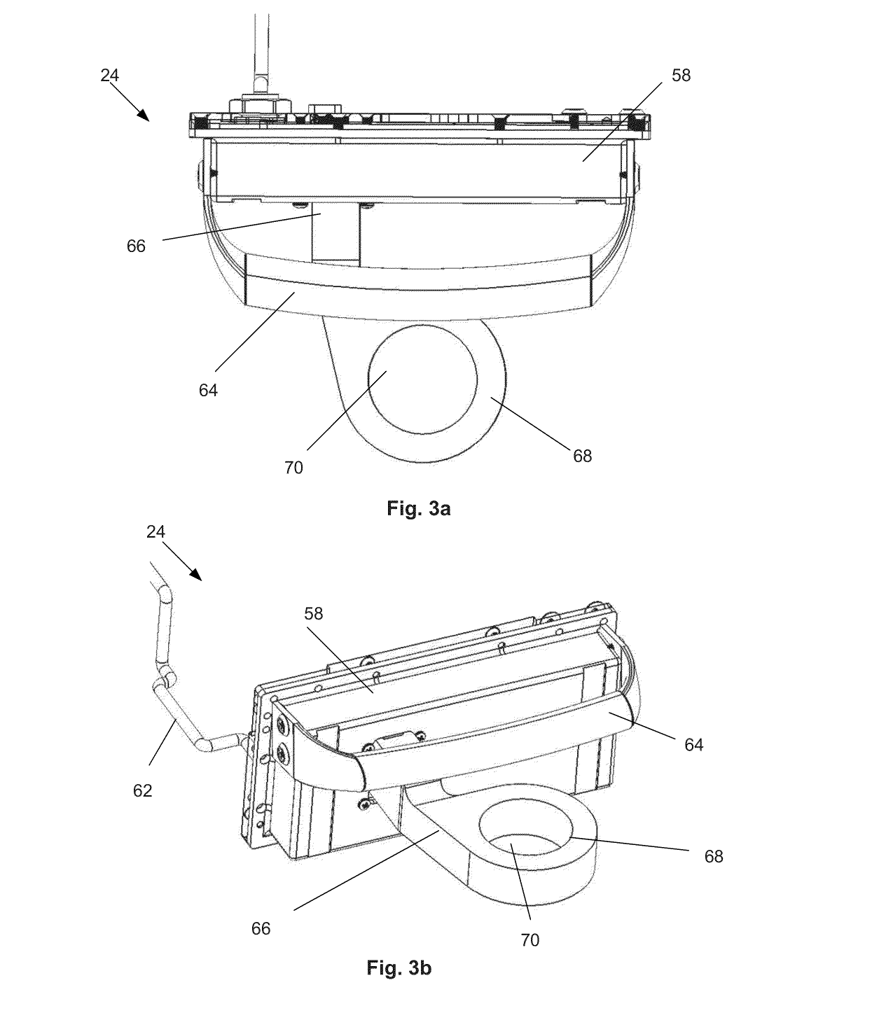

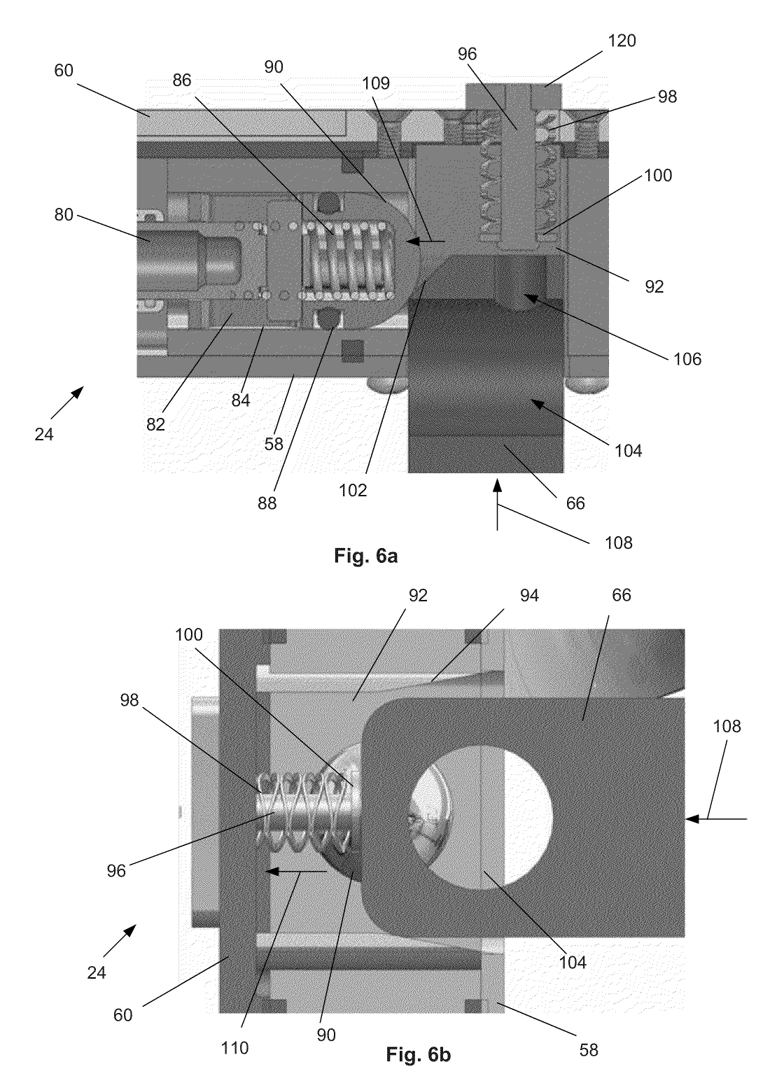

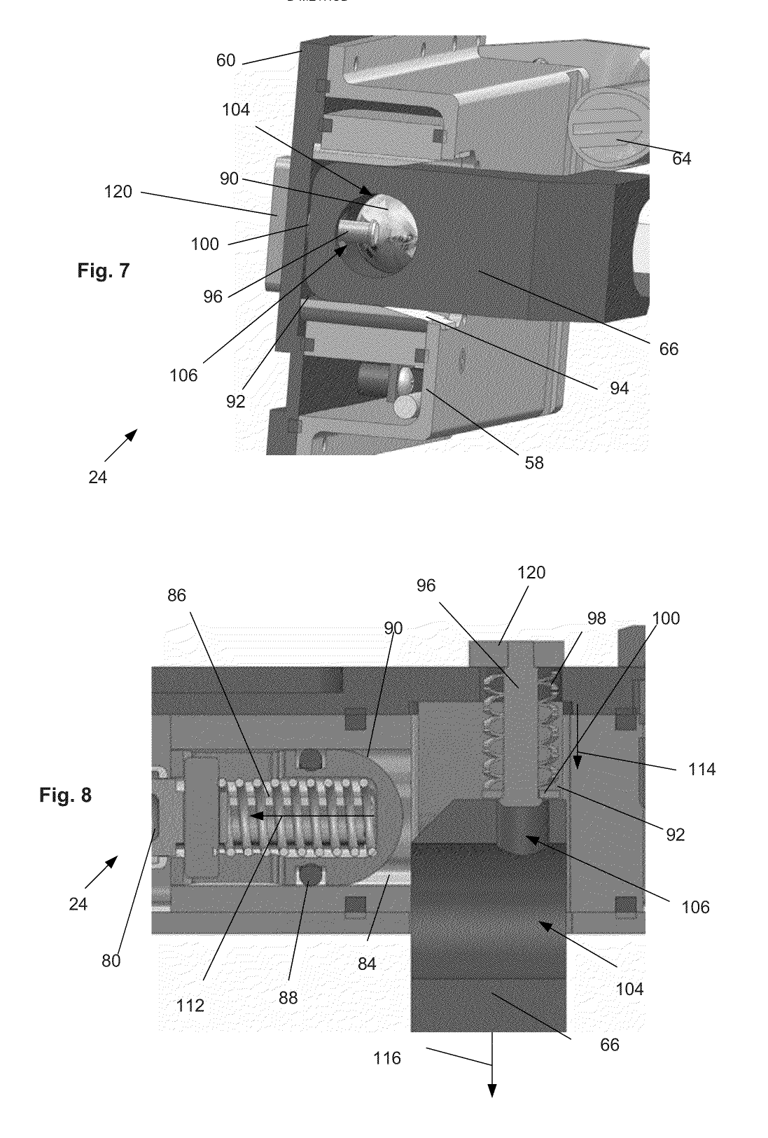

FIGS. 3a and 3b illustrate that the hitch 24 can have a hitch cover 58. The hitch cover 58 can cover a hitch frame 60 and/or the actuation components of the hitch 24, for example as shown in FIGS. 6a through 7c. The hitch cover 58 and/or hitch frame 60 can be removably attached to the rear terminal end of the body of the robot 10.

The hitch assembly can have a hitch binder cable 62. The hitch binder cable 62 can connect the hitch 24 to the power and data communication electronics of the remainder of the robot 10. The binder cable 62 can deliver power to the hitch 24 and send the data signal to release to the hitch 24. The binder cable 62 can send feedback from the hitch 24 to the robot 10. The robot 10 can communicate the status (e.g., open, closed, whether attached or not attached to the trailer 12, the type of trailer 12 perhaps identified by a signal detected from the trailer coupler, the weight of the trailer 12, the resisting or drag force from the trailer 12) of the hitch 24 to the remote control.

The binder cable 62 can connect to the control system of the robot 10. The binder cable 62 can plug in to the main body of the robot 10. The hitch 24 can have a wireless connector and/or direct connector with or instead of the binder cable 62. The direct connector can plug into the robot 10 (or the robot 10 can have a plug that enters the connector) while attaching the hitch 24 to the robot 10. The wireless connector can communicate (e.g., via Bluetooth) with the data and/or power systems on the robot 10. The connectors and/or binder cable can transmit the data transfer to and from the microprocessor that controls the actuator, and for example one or more processors in the robot body. The hitch 24 can have a separate power source (e.g., a hitch battery) than the power source of the remainder of the robot 10.

The hitch 24 can have a hitch handle 64. The hitch handle 64 can be attached to the hitch cover 58 and/or hitch frame 60. The hitch handle 64 can extend rearward from the hitch frame 60.

The hitch 24 can have a hitch receiver 66. The hitch receiver 66 can extend rearward from the hitch cover 58. The hitch receiver 66 can have a hitch receiver ring 68 at the rear terminal end of the hitch receiver 66. The hitch receiver ring 68 can have a receiver port 70. The hitch receiver port 70 can be partially or completely encircled by the receiver ring 68. The trailer coupler 50 can attach to the receiver port 70.

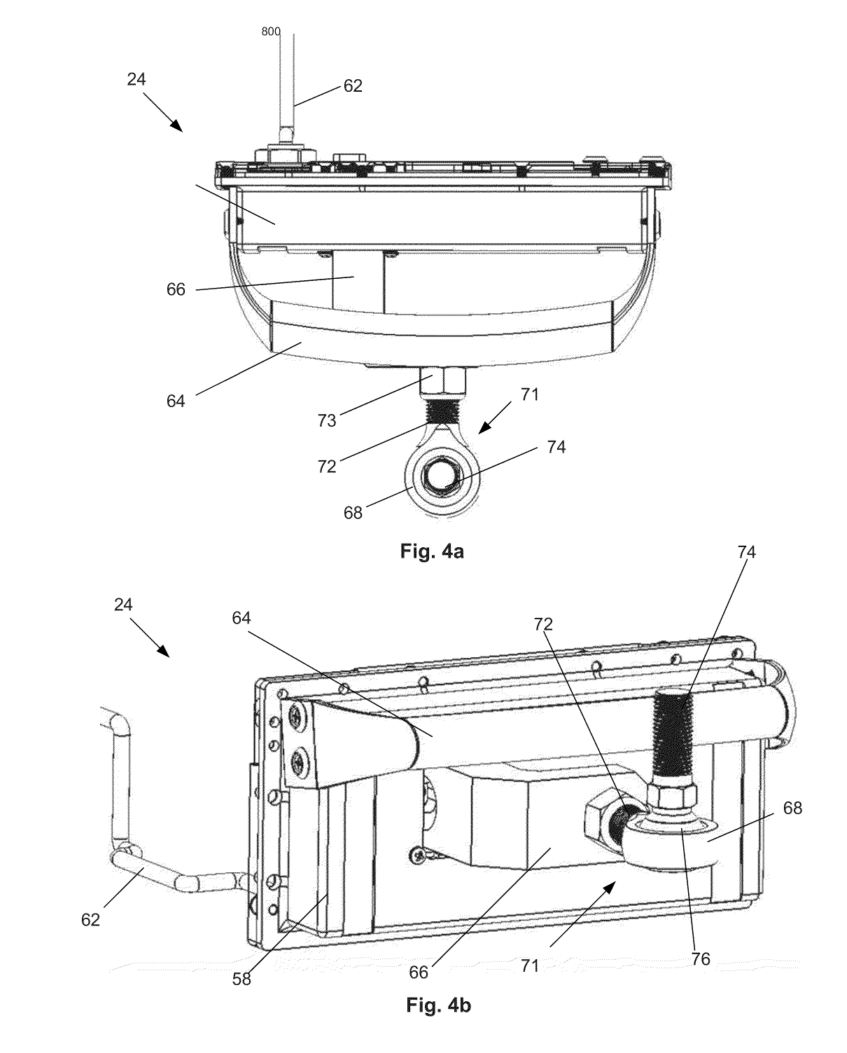

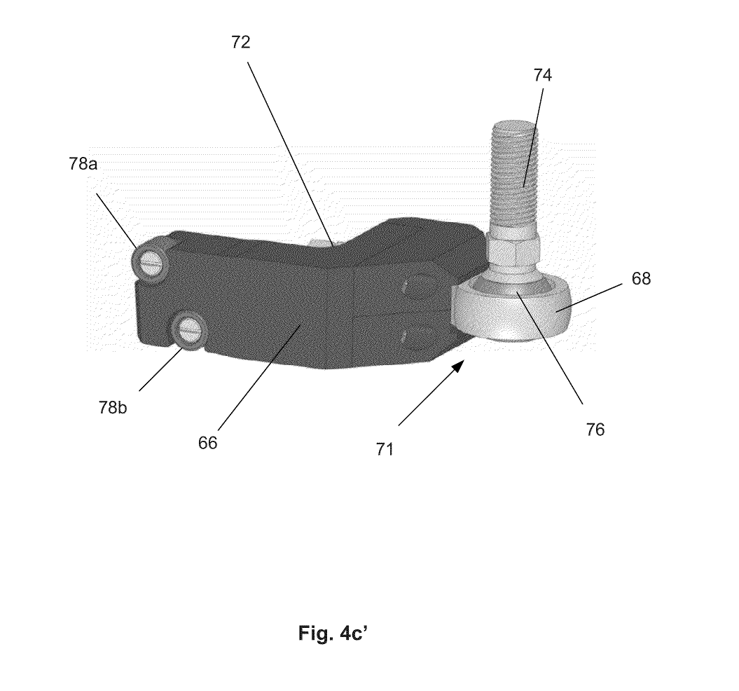

FIGS. 4a, 4b and 4c′ illustrate that the receiver 66 can have a receiver assembly 71 extending rearward. The receiver assembly 71 can permit three degrees of freedom of rotation between the hitch 24 (and therefore the robot 10) and the trailer 12. The receiver assembly 71 can have a bolt extender 72 threadably attached to the portion of the receiver 66 extending directly from the hitch cover 58. A locknut 73 can be tightened on the extender 72 against the remainder of the receiver 66 to rotationally fix the extender 72 to the portion of the receiver 66 extending directly from the hitch cover 58. The rear terminal end of the extender 72 can be the receiver ring 68. A trailer attachment bolt 74 can extend vertically upward (as shown) or downward from the receiver ring 68. The trailer attachment bolt 74 can extend short of, to, or past (as shown) the height of the bottom or top of the hitch handle 64. The trailer attachment bolt 74 can be threaded.

The trailer attachment bolt 74 can terminate in the receiver ring 68 with a trailer attachment ball 76. The inner radius of the receiver ring 68 can have a partially spherical shape (i.e., the surface can have a radius of curvature from the center of the ring 68 vertically and horizontally). The attachment ball 76 can rotate in the receiver ring 68 in one (e.g., about a vertical axis, for example if the ball 76 has a ring extending radially that is bound within a horizontal groove in the inner diameter of the receiver ring 68), two or three dimensions. The ball 76 can be translationally fixed inside of the receiver ring 68. The trailer 12 can be attached to the trailer attachment bolt 74.

FIG. 4c′ illustrates that the receiver 66 can have one or more rollers 78, for example the receiver top roller 78a and the receiver bottom roller 78b. The receiver top roller 78a can be at the front terminal end of the receiver 66. For example, the receiver top roller 78a can be the longitudinal terminus of the receiver 66. The receiver top roller 78a can extend above the top of the receiver body. The receiver bottom roller 78b can be longitudinally even with or rear of the receiver top roller 78a. The receiver bottom roller 78b can extend below the bottom of the receiver body. The receiver rollers 78 can be configured to roll against the receiver guides and/or the walls of the receiver channel (shown in FIGS. 6a, 8, and 9a through 9c.

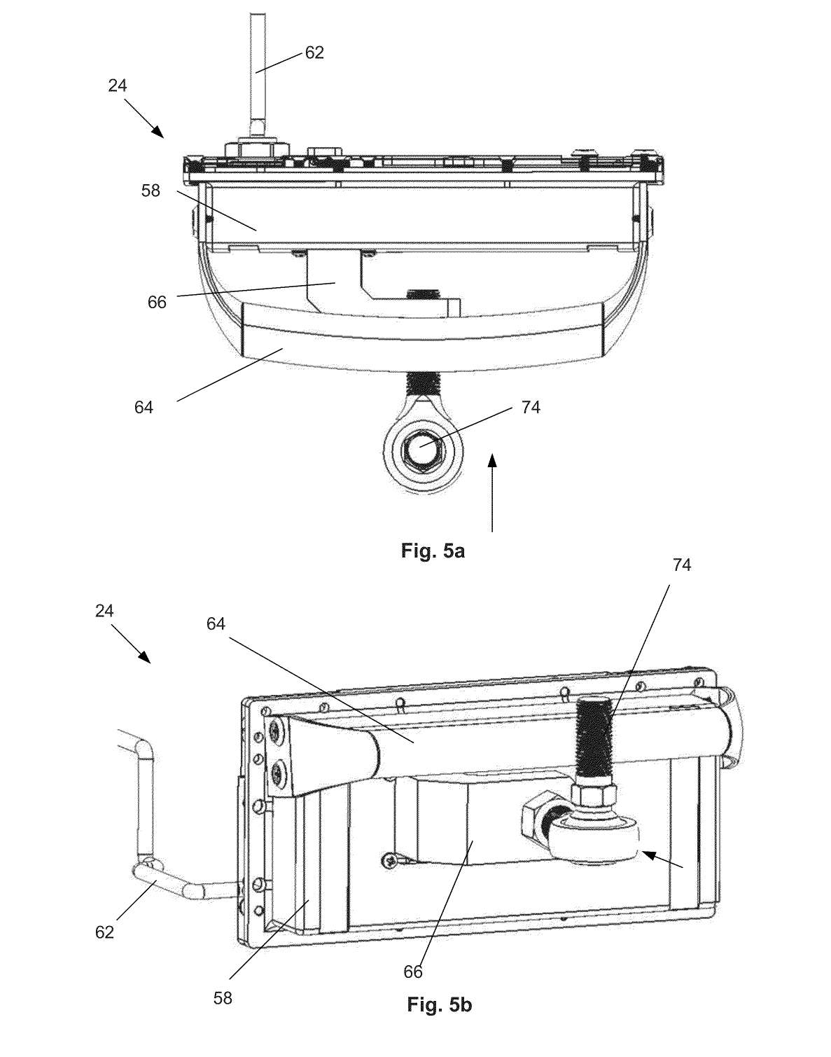

FIGS. 5a and 5b illustrate that the receiver 66 can be actuated to retract, as shown by arrow, the receiver 66 in the direction of the hitch cover 58 and robot 10. The receiver 66 can be actuated to release and detach from the remainder of the hitch 24. If the receiver 66 is attached to the trailer 12, detaching the receiver 66 from the remainder of the hitch 24 can detach the trailer 12 from the robot 10. The hitch 24 can be actuated through a signal received from a remote control by the robot 10 and, for example, transmitted to the hitch 24 by the robot 10 through the binder cable 62.

Instead of or in addition to the receiver ring 68 and/or the bolt 74, the hitch 24 can have one or more clamping jaws (e.g., a pintle hook), tow pins, balls, lunette rings, or combinations thereof.

FIGS. 6a and 6b illustrate that the hitch 24 can have a hitch frame 60 attached to the hitch cover 58. The hitch frame 60 can be attached to the body of the robot 10. The hitch 24 can have an actuator 80, such as a linear actuator that has a motor and acme screw, a ball screw or roller screw, a linear motor, solenoid, or combinations thereof.

The actuator 80 can be actuated by a signal transmitted by the remote control to the robot 10 and from the robot 10 through the binder cable 62. The actuator 80 can be actuated by a signal autonomously generated by the robot 10, for example if the robot 10 detects the trailer 12 and/or robot 10 are motion impaired or translationally or rotationally fixed or that the robot 10 has reached the trailer's destination, the robot 10 can actuate the actuator 80 to detach the trailer 12 from the robot 10.

The actuator 80 can be fixed to a plunger 82. The hitch 24 can have a plunger channel 84. The plunger 82 can slidably translate in the plunger channel 84. The plunger 82 can be attached externally and/or internally (as shown) to an actuator retraction spring 86. The plunger 82 can have a plunger gasket or plunger seal 88 between the plunger 82 and the wall of the plunger channel 84. The distal terminal end of the plunger 82 can be a hemispherical dome 90. The dome 90 can be a ball detent. The dome 90 can have a smooth or textured (e.g., knurled) surface.

The hitch 24 can have a receiver channel 92. The receiver channel 92 can be oriented perpendicular to the plunger channel 84. The receiver channel 92 and plunger channel 84 can open into each other (i.e., can be in fluid communication with each other). The receiver channel 92 can have sloped receiver guides 94 on the watts of the receiver channel 92. The receiver guides 94 can guide the receiver 66 into the receiver channel 92 when the receiver 66 is slid into the receiver channel 92.

The hitch 24 can have a dome stop pin 96. The dome stop pin 96 can extend parallel with and into the receiver channel 92. The distal terminal end of the dome stop pin 96 can be wider than the remainder of the shaft of the dome stop pin 96.

The dome stop pin 96 can be encircled by a release spring 98. The release spring 98 can be a coil spring. A release spring washer 100 can encircle the dome stop pin 96 distal to the release spring 98. The release spring washer 100 can abut and stop against the widened distal tip of the dome stop pin 96. The release spring 98 can be biased to expand against the release spring washer 100 when the release spring washer 100 abuts the distal tip of the dome stop pin 96.

The receiver 66 can have a dome ramp 102. The dome ramp 102 can have a flat, angled or a convex curved surface on the front terminal end of the receiver 66 on the side of the receiver 66 fixing the plunger 82.

The receiver 66 can have a hitch lock port 104 near the front terminal end of the receiver 66. The hitch lock port 104 can extend through most or all of the width of the receiver 66. The hitch lock port 104 can extend parallel with the plunger channel 84. The hitch lock port 104 can have a diameter equal to or larger than the diameter of the plunger 82.

The receiver 66 can have a dome stop pin port 106. The stop pin port 106 can extend from the front terminal end of the receiver 66 into the hitch lock port 104. The stop pin port 106 can be at least as wide as the maximum width of the dome stop pin 96.

The receiver 66 can be translated, as shown by arrow 108, into the receiver channel 92. The front terminal end of the receiver 66 can be slid into the receiver channel 92, for example against the receiver guides 94. The dome ramp 102 can press against the dome 90, for example sliding against and pushing the dome 90 out of the way of the receiver 66 as the receiver 66 translates into the receiver channel 92. The actuator retraction spring 86 can be biased to contract and pull the plunger 82 away from the receiver channel 92 and the receiver 66, as shown by arrow 109. The receiver 66 can be pushed into the receiver channel 92 while the actuator 80 is actuated or not actuated. For example, if the actuator 80 is actuated, the force of receiver 66 can exceed the resistive force caused by friction between the dome 90 and the dome ramp 102.

As the receiver 66 is slid into the receiver channel 92, the dome stop pin port 106 can pass over the stop pin 96. The stop pin 96 can extend into the hitch lock port 104. The receiver 66 can abut the release spring washer 100 and compress the release spring 98, as shown by arrow 110 in FIG. 6b.

FIG. 7 illustrates that the actuator 80 can be actuated, for example, forcing the plunger 82 toward the receiver 66. The dome 90 and/or distal end of the plunger 82 can translate into the hitch lock port 104. The dome 90 can abut and stop against the dome stop pin 96 in the hitch lock port 104. The plunger 82 positioned in the hitch lock port 104 can fixedly attach the receiver 66 to the remainder of the hitch 24. When the receiver 66 is in the receiver channel 92 and the plunger 82 is in the hitch lock port 104, the receiver 66 can compress the release spring 98.

FIG. 8 illustrates that the actuator 80 can be deactivated, for example when the actuator 80 is turned off and/or the hitch 24 loses power (e.g., the robot 10 loses power, for example if the robot battery dies). The actuator retraction spring 86 can be biased to pull the plunger 82 and the actuator 80 out of the hitch lock port 104 and away from the receiver 66. With the actuator 80 deactivated, the actuator retraction spring 86 can translate the plunger 82, as shown by arrow 109.

The release spring 98 can longitudinally expand, as shown by arrow 114. The release spring 98 can press the release spring washer 100 against the front terminal end of the receiver 66. The release spring washer 100 can translate along the dome stop pin 96 and push the receiver 66. The receiver 66 can translate, as shown by arrow 116, along and out of the receiver channel 92. The receiver 66 can exit the receiver channel 92 entirely. The receiver 66 can release and separate from the remainder of the hitch 24.

The hitch 24 can have a manual fixation element, such as a pin, bolt or other mechanical element or combinations thereof, to fix the plunger 80 in a position in the hitch lock port 104 or out of the hitch lock port 104. For example, the plunger 80 can be fixed in the hitch lock port 104 during shipping of the hitch 24 or to keep the trailer attached to the robot 10 in case of loss of power.

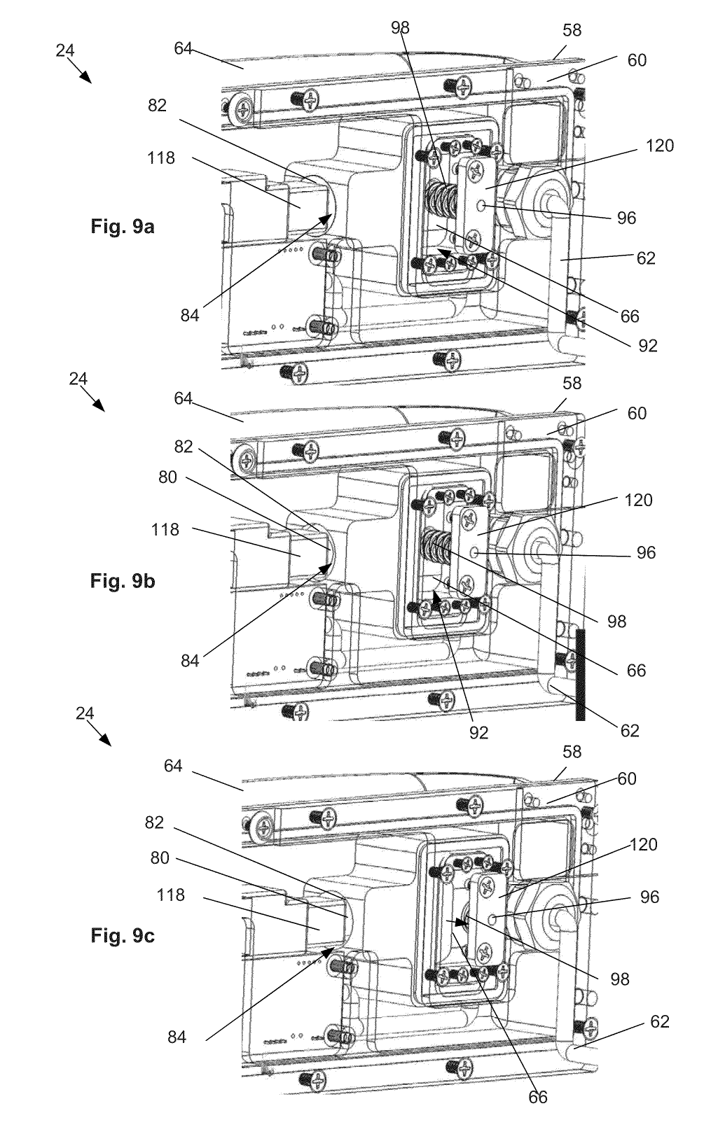

FIG. 9a illustrates that the hitch 24 can have an actuator case 118. The actuator 80 can be unactuated. The actuator 80 can be partially or completely in the actuator case 118. The hitch plunger 82 can abut and/or be adjacent to the actuator case 118.

The dome stop pin 96 can be attached to a dome stop pin backing 120. The release spring 98 can be substantially uncompressed between the dome stop pin backing 120 and the release spring washer 100.

The receiver 66 can be removed entirely from the receiver channel 92 or inserted into the receiver channel 92 but not fixed to the remainder of the hitch 24.

FIG. 9b illustrates that the actuator retraction spring 86 can be compressed and the actuator 80 can be actuated. The plunger 82 can press against the side of the receiver 66, for example on the dome ramp 102.

FIG. 9c illustrates that the receiver 66 can be translated forward into the receiver channel 92, as shown by arrow. The receiver 66 can compress the release spring 98 between the receiver 66 and the dome stop pin backing 120.

The actuator 80 can be actuated, pushing the actuator 80 and plunger 82 toward the receiver 66. The receiver 66 can be translated forward into the receiver channel 92 while the actuator 80 is actuated. For example, the plunger 82 can slide and snap into the hitch lock port 104 as the receiver 66 is pushed into the receiver channel 92, locking the receiver 66 into the receiver channel 92.

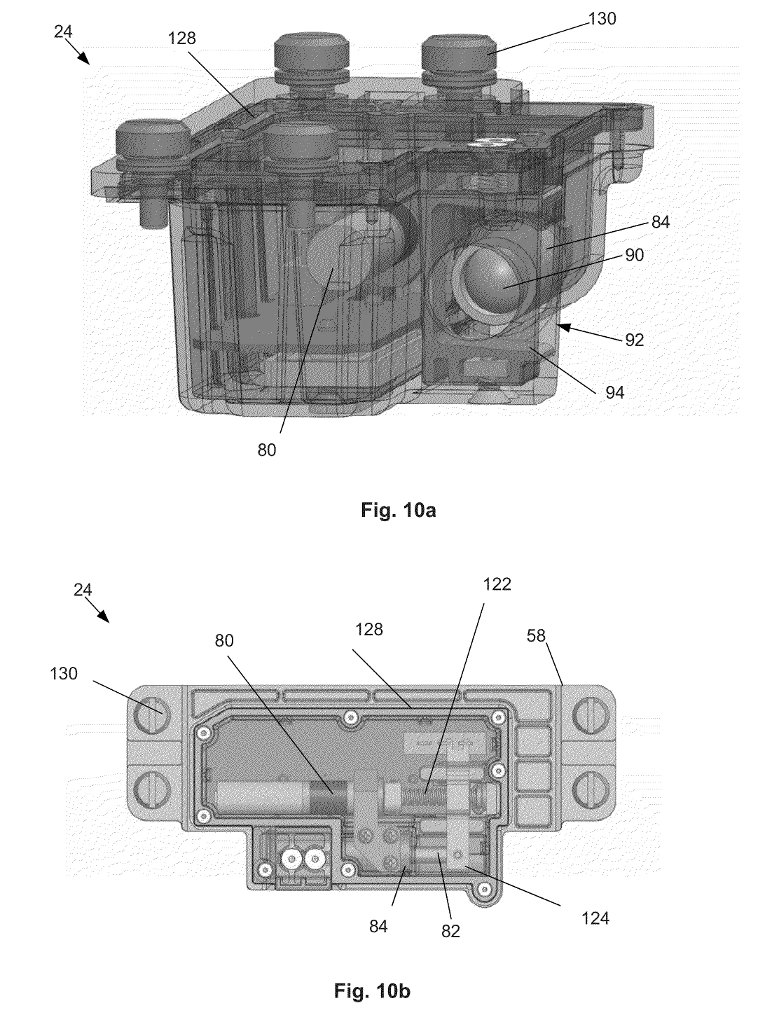

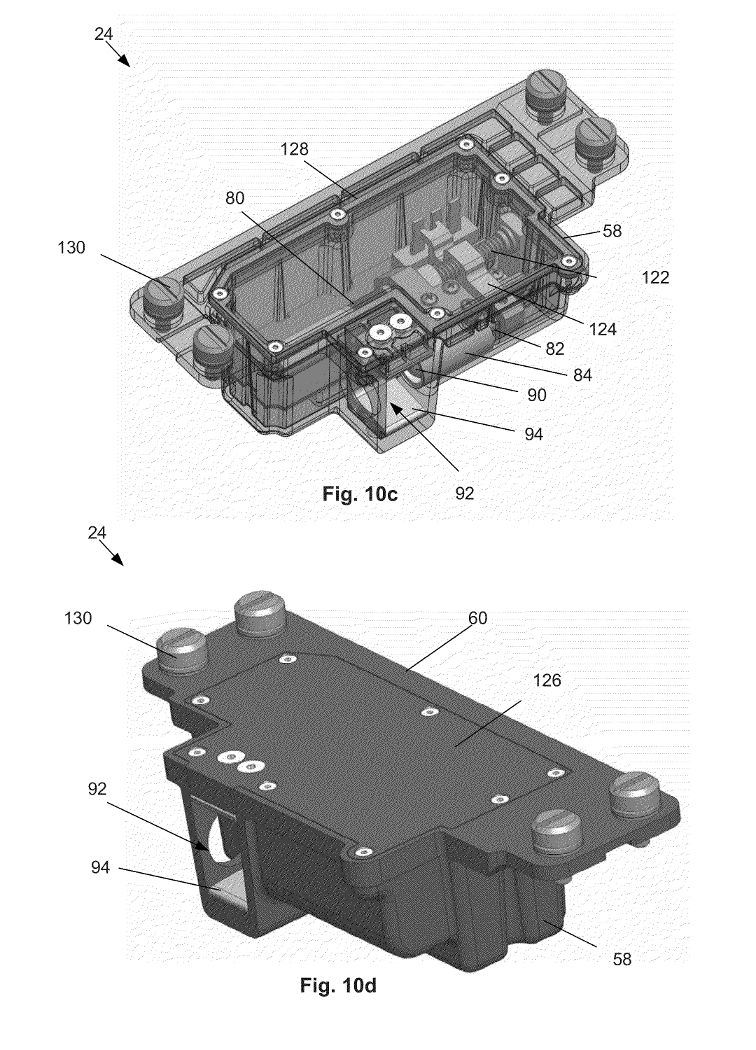

FIGS. 10a through 10d illustrate that the actuator 80 can be or have a rotational electric motor. The motor can be attached to a transmission to transfer the power from the motor to the plunger 80. The transmission can have an actuator gear or screw 122, such as an acme screw, roller screw, ball screw, a gear or gearing (e.g., combination of gears), or combinations thereof attached directly to the motor. The actuator screw or gear 122 can be treadably attached to an actuator arm 124. The actuator arm 124 can be attached to the plunger 82. When the motor rotates, the actuator screw and/or gear 122 can rotate. When the actuator screw 122 rotates, the actuator arm 124 can translate along the length of the screw 122. When the actuator arm 124 translates, the plunger 82 can translate. The motor can be rotated in either direction. The motor can control the translation toward and away from the receiver channel 92 (and the hitch lock channel when the receiver 66 is in the receiver channel 92). The motor and gear can be oriented parallel to the plunger channel 84. The rotational electric motor, actuator gear 122 and actuator arm 124 can function as a linear actuator.

The hitch 24 can have a hitch lid 126. The hitch lid 126 can be removably attached to the hitch cover 58 and/or hitch frame 60. The hitch 24 can have a hitch cover gasket 128. The hitch cover gasket 128 can seal (e.g., water-tight and/or air-tight) the hitch lid 126 against the hitch cover 58 and/or frame 60 when the hitch lid 126 is attached to the remainder of the hitch 24.

The hitch 24 can have one or more (e.g., four as shown) robot attachment bolts 130. The robot attachment bolts 130 can attach to the hitch cover 58 and/or hitch frame 60. The robot attachment bolts 130 can attach to the robot body and/or the hitch handle 64.

More than one range or example of quantities can be provided for a characteristic as alternative contemplated ranges and examples. Elements, characteristics and configurations of the various variations of the disclosure can be combined with one another and/or used in plural when described in singular or used in plural when described singularly.

1. A vehicular connection system comprising:
a vehicle comprising a chassis and a hitch, and wherein the hitch is configured to be remotely controlled; and
a trailer comprising a bed, a wheel, and a coupler, and wherein the coupler is releasably attachable to the hitch.

2. The system of claim 1, wherein the hitch is configured to be remotely activated by a wireless signal.

3. The system of claim 1, wherein the hitch comprises a linear actuator.

4. The system of claim 1, further comprising a flipper rotatably attached to the chassis.

5. The system of claim 1, wherein the bottom of the front frame of the trailer has a radius of curvature of less than 12 in.

6. The system of claim 1, wherein the front bottom panel is at an angle of less than 50′ with respect to the bed.

7. The system of claim 1, wherein the vehicle comprises a robot, and wherein the robot is configured to be remotely controlled.

8. The system of claim 1, wherein the vehicle is configured to be remotely controlled.

9. The system of claim 1, wherein the hitch comprises a receiver, and wherein the receiver is removably attached to the remainder of the hitch.

10. The system of claim 9, wherein the receiver comprises a first roller and a second roller, and wherein the first roller is on a first side of the receiver, and wherein the second roller is on a second side of the receiver, and wherein the first roller is longitudinally distal to the second roller.

11. A trailer comprising:
a frame;
a bed on the frame;
coupler attached to the frame;
a wheel having a wheel axis, wherein the wheel axis is attached to the frame; and
wherein the bottom of the front frame of the trailer has a radius of curvature of less than 12 in.

12. The system of claim 11, wherein he front bottom panel is at a angle of less than 50° with respect to the bed.

13. The system of claim 11, wherein the rear bottom panel is at an angle of less than 50° with respect to the bed.

14. The system of claim 11, wherein the frame is lower than the bed, and wherein the wheel axis is above the bottom of the frame.

15. A method of using a vehicular connection system comprising:
attaching a first vehicle to a trailer;
remotely controlling the first vehicle, wherein remotely controlling comprises sending a signal from a control unit to the first vehicle;
detaching the first vehicle from the trailer, wherein detaching comprises sending a wireless signal to the first vehicle.

16. The method of claim 15, wherein the first vehicle comprises a robot.

17. The method of claim 15, wherein the first vehicle comprises a hitch.

18. The method of claim 17, wherein the hitch comprises a linear actuator.

19. The method of claim 18, wherein attaching comprises actuating the linear actuator.

20. The method of claim 18, wherein detaching comprises deactivating the linear actuator.
